(19) United States
(12) Patent Application Publication
(10) Pub. No.: US 2007/0299694 A1
(43) Pub. Date: Dec. 27, 2007

(54) Patient education management database system

(76) Inventor: David E. Merck, West Springfield, MA (US)

Correspondence Address: MCCORMICK, PAULDING & HUBER LLP, CITY PLACE II, 185 ASYLUM STREET, HARTFORD, CT, 06103, US

(21) Appl. No.: 11/474,649

(22) Filed: Jun. 26, 2006

(51) Int. Cl. G06F 19/00; H04N 7/16; G09B 23/28

(52) U.S. Cl. 705/3; 434/262; 725/9

(57) ABSTRACT

A patient education system includes a server computer and a wireless tablet computer. A database on the server includes a number of default “presentation prescriptions,” each of which is a listing of educational sub-topics selected to provide an overview of a medical condition for patient education purposes. Each sub-topic has a corresponding content file (e.g., film clip) stored on the tablet computer. In operation, one of the default prescriptions is selected for providing educational content relevant to a patient's medical condition. Some of the sub-topics may be removed for customizing the default prescription. The tablet computer is given to the patient, and an education presentation is displayed according to the presentation prescription, e.g., the content files that correspond to the topics in the selected presentation prescription are sequentially displayed. The patient's progress in viewing the presentation may be tracked, including the patient's answers to any questions in the presentation.

### FIELD OF THE INVENTION

The present invention relates to education and demonstration and, more particularly, to patient education using audio and visual means within a medical context.

### BACKGROUND OF THE INVENTION

When seeking medical care, it is customary for the patient and/or the patient's family to be provided with information relating to the patient's medical condition, including background information of the disease or condition, options for treatment, and prognosis. Typically, a physician or nurse carries out such patient education by informally talking with the patient and family members. However, due to the informal nature of this process, it is possible that patients may not be provided with as much information as they should, or that certain key points are missed. Additionally, the effectiveness of educating patients in this manner is also dependent on the medical professionals' communication skills, and on the education or comprehension level of the patient. Still further, it may be difficult for patients to understand complex points if the patients' interactions with medical professionals are primarily or mostly oral in nature.

Gaps or lapses in patient education are undesirable from the patient's perspective, since they may lead to a misunderstanding of treatment options, as well as unrealistic expectations of possible outcomes and of what to expect during treatment. They may also prove problematic in terms of malpractice claims, if it is shown that a procedure was undertaken without informed consent. Relying on traditional methods of patient education may also make it more difficult for a physician or medical facility to meet certain accreditation standards, e.g., JCAHO (Joint Commission on Accreditation of Healthcare Organizations) standards, which require a certain degree and thoroughness of patient education. It is difficult to show that traditional methods meet such standards, because there is no way to track what is communicated to patients, or whether they comprehend the material. Using traditional patient education methods may also lead to increased malpractice insurance premiums, for similar reasons.

### SUMMARY OF THE INVENTION

An embodiment of the present invention relates to an education management database system. The system includes a client terminal/computer, which may include a display, a memory unit, and input/output means such as a display, keyboard, and/or pointer device. The client terminal includes a control module or program that is configured to automatically display an education presentation to an individual according to an education “prescription.” The education prescription is a list of sub-topics each relating to an education topic. The sub-topics are selected based on the education status of the individual in relation to the general topic. (By “education status,” it is meant the degree or extent of education or experience that a patient has previously received in regards to a topic.) The progress of the presentation is tracked during display to the individual. The presentation may include audiovisual (AV) content and text content.

In another embodiment, the system is configured for patient education. Here, a medical education presentation is automatically displayed to a patient according to a presentation/education prescription. The presentation prescription is based on the medical condition of the patient, e.g., the presentation prescription includes a number of selected educational content sub-topics relevant to the patient's medical condition. Progress of the medical education presentation is automatically tracked during display to the patient.

In another embodiment, the presentation includes a number of questions relating to the AV content and/or text content. Patient answers to the questions are tracked, including possible storage in the patient's hospital record. Reports may be generated and stored in the patient's record for indicating the extent and progress of education received by the patient, including answers to any questions included in the presentation.

In another embodiment, a number of default presentation prescriptions are provided. Each default presentation prescription is a listing of educational topics and sub-topics relating to a particular disease, medical procedure, or other medical condition, that has been developed or selected (e.g., by medical experts) to provide a brief but thorough overview of the medical condition for patient education purposes. Using the default prescriptions as a starting point, a medical professional or other user selects the default presentation most relevant to a patient's condition. The user may then customize the selected default prescription depending on the particular needs of the patient, e.g., by removing or de-selecting one or more of the content options in the default prescription.

In another embodiment, each default prescription sub-topic has a corresponding content file, and all the content files for all the default prescriptions are stored on the client/patient terminal. A patient's prescription is accessed, and the content files corresponding to the sub-topics in the prescription are sequentially displayed on the patient terminal for the presentation. Alternatively, instead of local storage, content files may be streamed over a network.

The patient terminal may be a wireless unit, e.g., a wireless tablet computer. A presentation prescription is selected (e.g., a default prescription is selected and possibly customized) and transmitted to the wireless tablet computer. The tablet computer then automatically displays an education presentation based on the received prescription. Alternatively, education presentations can be viewed on a hospital terminal, or on a hospital's integrated television system. Education presentations may also be displayed through a web interface.

### BRIEF DESCRIPTION OF THE DRAWINGS

The present invention will be better understood from reading the following description of non-limiting embodiments, with reference to the attached drawings, wherein below:

FIGS. 1A and 1B are schematic views of a patient education management database system according to an embodiment of the present invention;

FIG. 2 is a schematic view illustrating the operation of an embodiment of the system;

FIG. 3 is a schematic view of a menu system portion of the patient education system;

FIG. 4 is a schematic view of a default presentation prescription;

FIG. 5 is a schematic view of an education presentation display;

FIG. 6 is a schematic view of a database portion of the system;

FIG. 7 is a schematic view of an integrated television system portion of the patient education management database system; and

FIG. 8 is a schematic view of an additional embodiment of the education system for direct web access.

### DETAILED DESCRIPTION

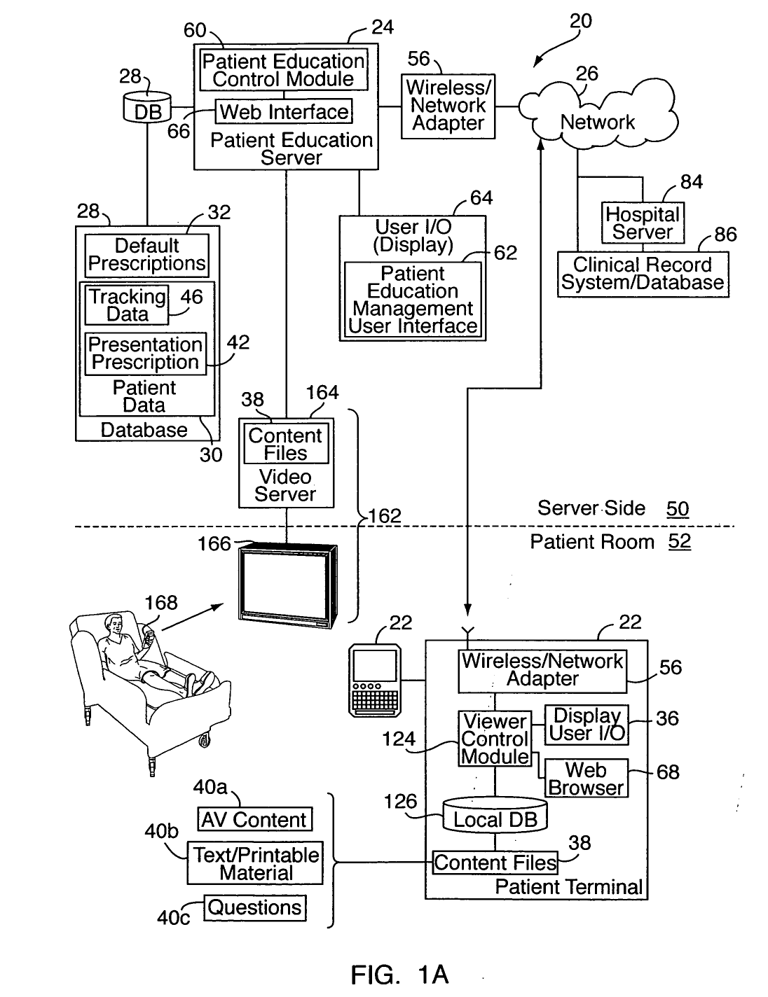

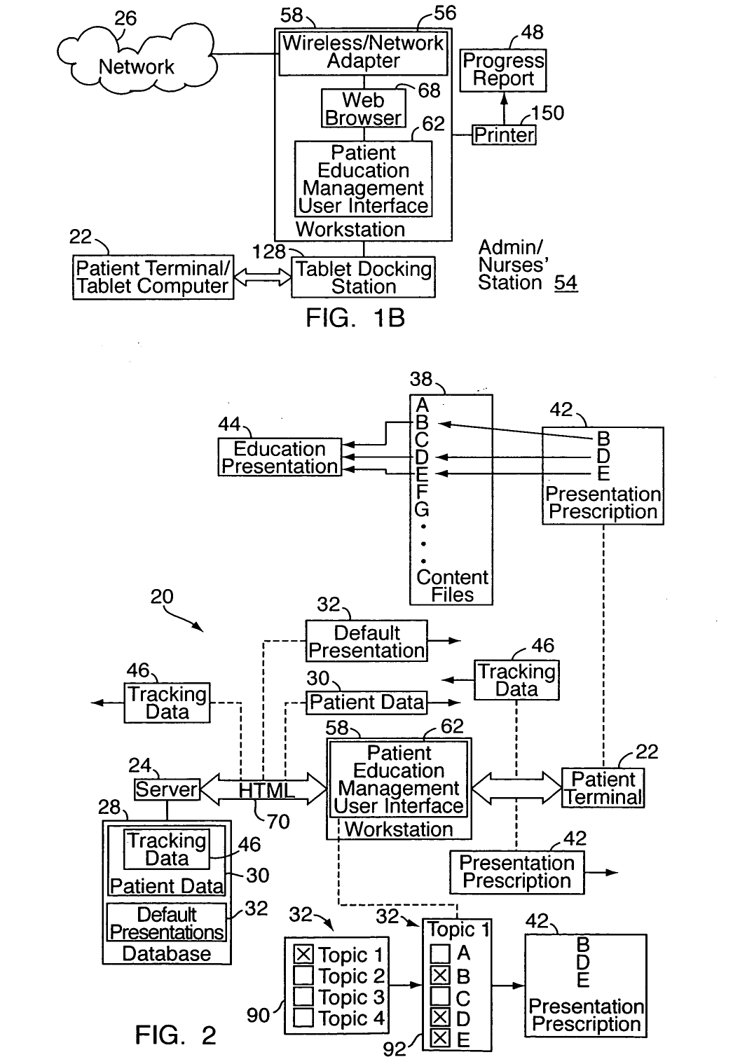

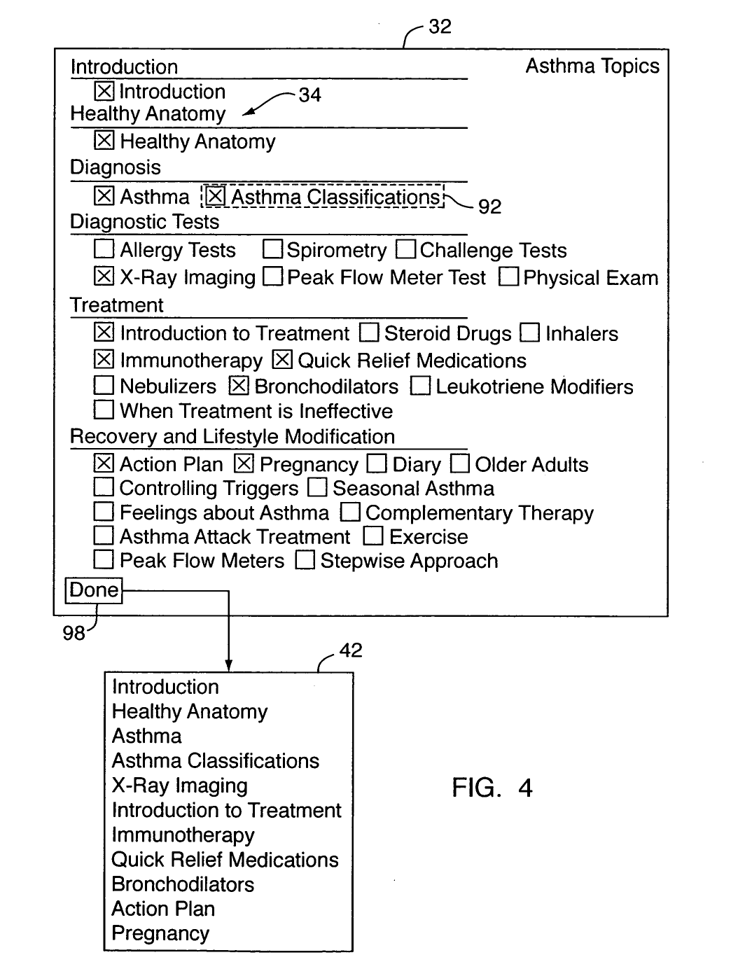

With reference to FIGS. 1A-7, a patient education management database system 20 includes a patient education client terminal 22 (“patient terminal”) and a patient education server terminal 24. The patient terminal 22 and server terminal 24 are configured to communicate with one another over a network 26. The patient terminal 22 may be a wireless unit such as a wireless tablet computer. The server terminal 24 includes a database 28 having one or more patient data records 30 and a number of “default” or baseline presentation prescriptions 32. Each default presentation prescription 32 is a listing of educational topics and sub-topics 34 relating to a particular disease, medical procedure, or other medical condition, that has been developed or selected to provide a brief but thorough overview of the medical condition for patient education purposes. (See FIG. 4.) The patient terminal 22 includes a display or monitor 36 and a number of content files 38 stored in memory. The content files 38 contain educational audiovisual (AV) content 40a (e.g., video clips or slide shows accompanied by an audio tract) and/or educational text content 40b (e.g., text slides or other text content for printing or display) relating to the topics and sub-topics 34 in the default presentation prescriptions 32. In other words, each topic or sub-topic 34 in each of the default presentation prescriptions 32 has a corresponding content file 38 stored on the patient terminal 22. The content files 38 may also contain various test questions 40c for testing patients on the educational content.

In operation, a user (e.g., nurse, doctor, or other medical professional) accesses the patient education server 24 and database 28. The user selects a patient listed in the database, or enters patient information to identify or designate a patient. The user then selects a default presentation prescription 32 applicable to the patient's particular medical condition. In other words, the default presentation prescription is selected for providing educational content relevant to the patient's medical condition. The user may then customize the default presentation prescription 32 by selecting or de-selecting one or more of the topics and sub-topics 34 listed in the default presentation prescription. The selected presentation prescription 42 (e.g., either the customized default presentation prescription, or the default presentation prescription if no customizations were made) is then transmitted to the patient terminal 22. (See FIG. 2.) The patient terminal 22 then automatically displays a medical education presentation 44, for showing to the patient or to the patient's family members, according to the presentation prescription 42. In particular, the patient terminal 22 sequentially displays the content files 38 that correspond to the topics in the selected presentation prescription 42; the sequentially displayed content files 38, correspondingly, comprise the medical education presentation 44. The patient views the medical education presentation, including possibly answering displayed questions. The patient terminal 22 tracks the patient's progress in viewing the presentation, and also tracks the patient's answers to the questions. For example, the patient terminal 22 may track which content files were viewed, the duration of viewing, and the like. Data 46 relating to the tracked progress and answered questions is sent back to the server 24 for storage in association with the patient's data record 30. (By “in association with,” it is meant stored as part of, or linked to.) The tracking data 46 may be used to generate a report 48 of the patient's progress, for printing out and/or storage.

As should be appreciated, the patient education system 20 allows a medical professional in a hospital or clinic setting to quickly and easily select educational content 44 to show to a patient. It also has the capability of testing the patient on the displayed content by posing questions 40c after the content has been displayed. The selected material is organized by the system into a unified program for playback, e.g., according to the presentation prescription 42. For example, the patient terminal 22 may link all the selected content files 38 together into a linear program 44 that the patient can watch like any other television program. As the content files 38 are displayed, the patient's progress is tracked, including what the patient watches and when, the questions the patient answers, and how the questions are answered. This information is stored in the database 28 for use by the hospital or other medical facility.

An embodiment of the patient education management database system 20 is shown in overview in FIGS. 1A and 1B. Generally speaking, components of the system are distributed across various locations in a hospital, doctor's office, or other medical facility. For example, as shown in FIGS. 1A and 1B, the medical facility is shown as including a “server side” 50, e.g., one or more rooms or other locations where server terminals are housed, a hospital room 52, and a nurses' station or other location 54 for carrying out patient care and/or administrative functions. These locations are functionally linked together by the network 26. The network 26 is a standard computer network such as a local area network (LAN), and can comprise a dedicated network (e.g., a network used only by the system 20), the medical facility's existing LAN/intranet, a public network such as the Internet, or a combination thereof. The network may be wholly or partially wireless in nature, with standard wireless network adapters 56 being utilized for wireless communication functions. The wireless adapters 56 may be standalone units, or they may be integrated or existing components of a computer terminal. For example, many laptop computers, tablet computers, and PDA's (personal digital assistants) come with built-in wireless functionality.

The patient education server terminal 24 is a standard server terminal/computer including mass storage for storing the database 28 and other data. The server terminal 24 acts as a central data repository and database interface for the system 20. For example, the system will typically include a number of patient terminals 22 for concurrent use by different patients. Each of the patient terminals 22 may occasionally access the server terminal 24 for depositing data, and for similar functions. The server terminal 24 may also be accessed by distributed workstation terminals 58 in the medical facility, as explained in more detail below. The server terminal 24 includes a patient education management control program or module 60. The management program 60 acts as a database interface, and may also include a patient education management user interface 62 for users to access patient information in the database, select default presentations 32, and customize the default presentations 32 based on a particular patient's needs or circumstances. The management program 60 and user interface 62 may be accessed in several ways. For example, the server terminal 24 may include direct user input/output (I/O) means 64, e.g., a touch screen, another type of display or monitor, a keyboard, and/or a mouse or other pointer device, for directly accessing the management program 60 and/or user interface 62. Alternatively, the management program 60 may include a remote interface program 66. The remote interface 66 is a program or sub-program that allows users at other terminals, e.g., the workstations 58 and/or patient terminals 22, to remotely access the server 24, database 28, and/or patient management program 60 over the network 26, via the user interface 62. For example, the remote interface 66 may be a “web” interface configured to transmit HTML-based files (or the like) to web-browser equipped terminals, in the same or similar manner as a server terminal communicates with a client terminal over the Internet for display and user interaction with Internet websites. For this purpose, the remote interface 66 and/or management program 60 includes a number of HTML files that form the patient education management user interface 62 when accessed through a web browser program.

As should be appreciated, the server terminal 24 and database 28 may be accessed in a number of different ways, and the present invention is not limited to any one particular client/server interface. As noted, the server terminal 24 may be directly accessed, or it may be configured as a web server for communicating with web browser-equipped terminals. The server terminal 24 could also be configured for direct access over a LAN. Alternatively, the server terminal and any client terminals (e.g., the patient terminals and workstations) could be configured to communicate with one another using a standard communication protocol or a protocol adopted especially for the patient education management database system 20. Still further, the server terminal 24 could be configured solely as a database or data repository, with the client terminals including patient education management user interface programs configured to remotely query the database over the network 26.

As noted, the management program 60 includes user interface functionality 62 for users to access the database 28 and select and customize default presentations 32. For example, if the management program 60 is configured for HTML-based, web-like access, a medical professional or other user may access the database 28 remotely from one of the medical facility's existing workstations 58. (See FIG. 1B.) The workstation 58 is outfitted with a standard web browser program 68 configured to access the server terminal 24, e.g., the web browser 68 is provided with a network address of the server terminal or the like. The user accesses the web browser in a standard manner through the workstation's user interface, e.g., display, keyboard, mouse, and operating system. Subsequently, the management program 60 and/or web interface 66 transmits HTML files/data 70 to the workstation 58 and web browser 68. (See FIG. 2.) The web browser 68 decodes these files in a standard manner for displaying the patient education management user interface 62 on the workstation's display.

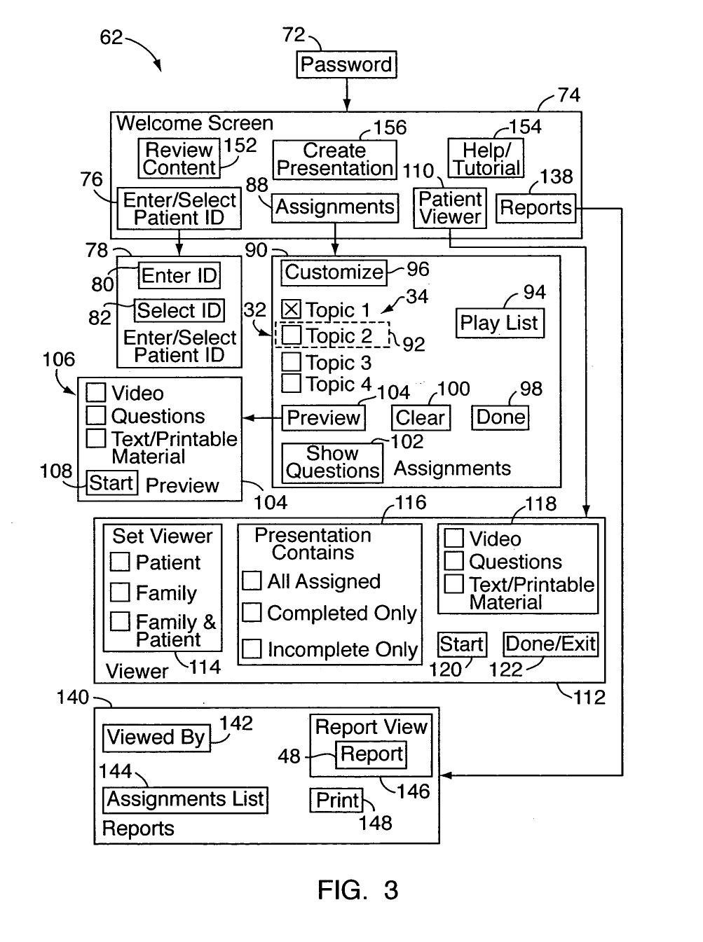

The user interface 62 may be configured in a number of different ways. One example is shown in FIG. 3. Upon accessing the user interface 62, an initial screen 72 is shown requiring the entry of a password. Entering an authorized password results in the display of a “welcome” screen or main menu 74. The welcome screen 74 includes a number of options for selecting patients, selecting/assigning presentation prescriptions 42, and the like. A first option is for selecting or entering patient identifiers (ID's) 76. Selecting this option takes the user to a patient ID screen 78. Typically, the system 20 uses each patient's unique ID, e.g., a hospital record number, patient name, or the like, for assigning presentation prescriptions, and to track the patient's progress in viewing educational content. Thus, the patient ID screen 78 includes an option 80 for entering a patient ID. Alternatively or in addition, the patient ID screen 78 may include an option 82 for selecting the patient's ID from a list of ID's of patients in the medical facility or some portion thereof, e.g., a floor, nursing unit, or hospital wing. For this purpose, the server 24 may be interfaced with the medical facility's main server computer 84 and/or clinical record system/database 86, using a virtual private network (VPN) link or the like. For example, the server terminal 24 could be configured to query or access the record system 86 to retrieve a list of patients in the appropriate nursing unit. Upon selecting or entering a patient ID, further patient-specific actions will be carried out with respect to the entered/selected ID, until a new ID is entered or selected.

The welcome screen or main menu 74 also includes an “assignments” option 88. Selecting this option takes the user to an assignments screen 90. The assignments screen 90 includes a listing of the default presentation prescriptions 32 in the database 28 and a “play list” 94. As noted, each default presentation prescription 32 is a listing of educational topics 34 relating to a particular disease, medical procedure, or other medical condition, that has been developed or selected to provide a brief but thorough overview of the medical condition for patient education purposes. For example, there might be default presentations for “cardiovascular,” “diabetes,” “asthma,” and “joint replacement,” among others. The default presentations are displayed in the form of “content options” 92. A content option 92 is an educational topic or sub-topic 34 that can be selected or de-selected using a checkbox, radio button, or the like. The play list 94 lists the content files 38 that will be displayed as part of a medical education presentation 44 for the patient, according to whatever content options 92 are currently selected. Associated with each default presentation 32 (main/general topic) displayed on the assignments screen 90 is a listing of the sub-topics that make up the default presentation. An example is shown in FIG. 4 for an “asthma” presentation. As indicated, the asthma topic is broken into sub-topics or portions including an “introduction,” a “healthy anatomy” section, a “diagnosis” section, and so on. Each section includes one or more content options 92 that can be selected or de-selected. The listing for each default presentation 32 is accessed by selecting a “customize” button 96 on the assignments screen 90, after first selecting the default presentation of interest. In other words, selecting the customize button 96 results in the display of the sub-topics comprising whatever default presentation has been selected on the assignments screen 90.

For creating an educational presentation 44 for a particular patient, a user enters or selects the patient's ID in the patient ID screen 78 and then selects the assignments option 88 on the welcome screen 74. The user then selects the default presentation 32 most relevant to the patient's condition, according to the listed topics 34. For example, if the patient is suffering from asthma, the user selects the default presentation for asthma by clicking on the appropriate checkbox. If the user wishes to assign all the content associated with this default presentation, the user simply selects a “done” option/button 98 on the assignments screen 90. The control program 60 then saves the selected default presentation as a presentation prescription 42 for the patient, in the patient's data record 30 in the database 28. If the user wishes to customize the selected default presentation, the user selects the customize button 96. This brings up the list of sub-topics associated with the general topic, as shown in FIG. 4. (The list may be shown on a separate screen, or it may be displayed in a window on the assignments screen 90, e.g., temporarily in place of the play list 94.) The user may then select or de-select one or more of the content options 92 in the sub-topic list, depending on the particular needs or characteristics of the patient. For example, some content options may only be relevant for patients of a particular age or gender. The content options may also be selected based on the patient's particular medical condition. For example, if the patient's doctor has ruled out certain forms of treatment for the patient, they may be de-selected from the list, since they are not necessary for the patient to view. Content options may also be selected based on the patient's education status with respect to the particular topic. (By “education status,” it is meant the degree or extent of education or experience that a patient has received in regards to a topic.) For example, if the user knows that the patient has already received some education relating to the medical condition from other sources, it may not be necessary to display an “introduction” content file. Once finished, the user selects the “done” option 98, and the customized default presentation prescription is saved in the patient's data record as a selected/assigned presentation prescription 42. As shown in FIG. 4, for example, a user has selected “introduction,” “healthy anatomy,” “asthma” (diagnosis), “asthma classifications” (diagnosis), and so on, which together subsequently form the presentation prescription 42. The presentation prescription 42 (e.g., the selected content options) are also shown in the play list 94, optionally along with the combined duration of the content files corresponding to the presentation prescription 42.

The assignments screen 90 may also include other functions, such as a “clear” option 100 for clearing all selected content options 92. Other options may include a “show questions” option 102 for selecting/de-selecting display of question content 40c in the play list 94, and a preview option 104. The preview option 104 is for previewing the educational presentation 44 that will be displayed to the patient, based on the presentation prescription 42. In particular, in this embodiment the presentation prescription 42 functions as a list that is used to guide the assemblage of content files 38 for sequential display to the patient. Each content option 92 in each default presentation prescription 32 has a corresponding content file 38 that includes AV content 40a, text content 40b, and/or questions 40c. Upon being directed to display the educational presentation 44, the content files 38 that correspond to the content options 92 in the presentation prescription 42 are sequentially accessed and displayed. The preview option 104 may include options 106 for selecting/de-selecting display of the AV content 40a, questions 40c, and text 40b during the preview, and a “start” option 108 for starting the preview.

Once a presentation prescription 42 has been assigned to a patient, the education presentation 44 may be displayed for the patient. For this function, the welcome screen 74 includes a “patient viewer” option 110. Selecting the patient viewer option 110 leads to a viewer screen 112. The viewer screen 112 includes a “set viewer” option 114, a “presentation contains” option 116, various options 118 for what to display, a “start” button 120, and a “done” or “exit” option 122. The set viewer option 114 allows a user to select who will be viewing the presentation, e.g., the patient, the patient's family, or both. The “presentation contains” option 116 allows a user to select the overall range of what is to be displayed, e.g., all assigned content, only completed content (content already viewed), or incompletely viewed content. For determining the latter two, the patient's data 46 (relating to the tracked progress of display) in the database 28 may be accessed. The options 118 allow the user to select/de-select display of the AV content 40a, questions 40c, and text or printed material 40b during the presentation.

Initiating display of the education presentation 44 may be carried out in one of several manners, depending on the particular configuration of the system 20 and where and how the management program 60 is accessed. For example, the management program 60 may be configured for direct access on the server terminal 24 through user I/O means 64, for displaying the presentation on the server terminal. In such a case, selecting the “start” button 120 on the viewer screen 112 causes the management program 60 to access the presentation prescription 42 associated with the currently-selected patient ID (e.g., the last patient ID selected or entered in the patient ID screen/window 78). The management program 60 then sequentially assembles/accesses the content files 38 that correspond to the selected content options 92/topics 34 in the prescription, for sequential display. Of course, this requires that the content files 38 be stored on the server terminal 24 Or in mass storage accessible to the server terminal. Alternatively, the management program 60 may be accessed on a workstation 58 through a web browser 68 and the interface 62, for displaying the presentation 44 on the workstation 58. In such a case, selecting the “start” button 120 on the viewer screen 112 causes the management program 60 and/or user interface 62 to access the presentation prescription 42 associated with the currently-selected patient ID, as either retrieved from the patient data record 30 or as stored in local memory on the workstation. The management program 60 and/or user interface 62 then sequentially assembles/accesses the content files 38 that correspond to the selected content options 92/topics 34 in the prescription, for sequential display. For this purpose, the content files 38 may be stored locally on the workstation 58.

Presentations 44 may also be displayed on patient terminals 22, e.g., wireless, portable tablet computers, laptop computers, PDA's, or the like. This facilitates portability, allowing the educational presentations to be easily and conveniently viewed in patient rooms or other locations where workstations 58 are not available. Portable computers also enable a patient to view and control a presentation without having to leave bed, which is especially advantageous for non-ambulatory patients. The patient terminal 22 may be configured as shown in FIG. 1A. For example, the patient terminal 22 may include a monitor/display and user I/O 36 (e.g., keyboard, stylus, touch screen, or the like), the content files 38 (stored in memory or mass storage), wireless capability 56, and a viewer control module or program 124. The patient terminal 22 may also include a local database 126 and a web browser 68. The viewer control module 124 is configured to display an education presentation 44 on the patient terminal's monitor/display 36, based on a presentation prescription 42 for the patient using the patient terminal 22, and to track progress of the display. In particular, subsequent to a presentation prescription being received by the patient terminal, and commencing with a “start” command, the viewer control module 124 sequentially assembles or accesses the content files 38 that correspond to the selected content options 92/topics 34 in the presentation prescription. The content files 38 are sequentially displayed on the monitor 36, and together form the education presentation 44 for the patient. The patient terminal 22 may be controlled for displaying education presentations in a number of manners. For example, the patent terminal 22 may be a stand-alone unit including not only the content files 38 but also the default presentation prescriptions 32. In such a case, the viewer control module 124 would mirror the functionality of the patient education management program 60 and/or management interface 62. A medical professional or other user would access the patient terminal and control module 124, select and possibly customize a default presentation 32 for a patient, and then direct the control module 124 to display the education presentation for the patient based on the selected presentation prescription. Although in this instance the control module 124 would largely be self contained in nature, the control module 124 could still be configured for (i) entry of a patient ID, (ii) for tracking patient progress and answers to questions, and (iii) for transmitting tracking data 46 back to a centralized server terminal 24, database 28, hospital sever 84, and/or clinical record system 86.

The patient terminal 22 may also be configured in a manner similar to the workstation 58, as described above. In such a case, a user would access the management program 60 through a web browser interface 68 outfitted on the patient terminal, for display of the management interface 62. The user would then select and possibly customize a default presentation 32 for a patient, and then select the “start” option 120 in the viewer screen 112. The patient terminal would then be given to the patient in question for display of the education presentation 44 based on the selected presentation prescription, as either stored in local memory subsequent to the selection/customization process or as received from the server terminal 24 over the network 26.

The patient terminal 22 may also be configured for control through a workstation 58. In other words, the workstation 58 is used to select and customize the default presentations 32 for assigning presentation prescriptions 42, and the patient terminal 22 is used for displaying the education presentations 44 and for tracking patient progress in regards to viewing the presentations and answering questions. In such a case, a user accesses the patient education management interface 62 on the workstation 58 as described above. Additionally, a patient terminal 22 is linked to the workstation, either wirelessly or through use of a docking station 128 connected to the workstation 58. For the former, the workstation 58 would be provided with information needed for wirelessly communicating with the patient terminal 22, e.g., a network address or identification of the patient terminal, possibly provided through a listing of patient terminals currently connected to the network 26. For the latter, the workstation 58 would be configured to communicate with whatever patient terminal 22 was currently docked in the docking station 128. After the user selects a presentation prescription 42 for a patient, the presentation prescription 42 is transferred to the patient terminal 22. If the patient terminal is connected to a docking station 128, the prescription 42 is transferred either from the server terminal through the workstation and to the patient terminal, or from local memory in the workstation to the patient terminal. If the patient terminal is configured for wireless communication, the prescription 42 will typically be transferred from the server terminal 24 to the patient terminal 22 over the network 26, e.g., after the user selects the “done” function 98 on the assignments screen 90 or otherwise. In either case, selecting the “start” option 120 on the viewer screen 112 (at the workstation 58) causes a command to be sent to the viewer control module 124 on the patient terminal 22, which subsequently displays the presentation 44 based on the prescription 42. The manner and timing in which the presentation prescriptions are transmitted to the patient terminals, and the manner and timing in which presentations are commenced, may vary.

Once a presentation prescription 42 has been assigned to a patient, it is possible for the education presentation 44 to be displayed right away. However, if the system is configured for the selected prescription 42 to be stored in memory for the user, e.g., in a patient data record 30 in the database 28, the education presentation 44 may instead be viewed later. In particular, upon entering a patient ID in the patient ID screen 78, the patient education management program 60 determines whether a presentation prescription 42 is stored in the database 28 for the patient. If so, the presentation prescription 42 is loaded/accessed for viewing by the patient or for modification by the medical professional or other user. The patient education management program 60 may be configured for the storage of more than one presentation prescription 42 for each patient, with the user being able to select among multiple stored prescriptions for modification and/or display.

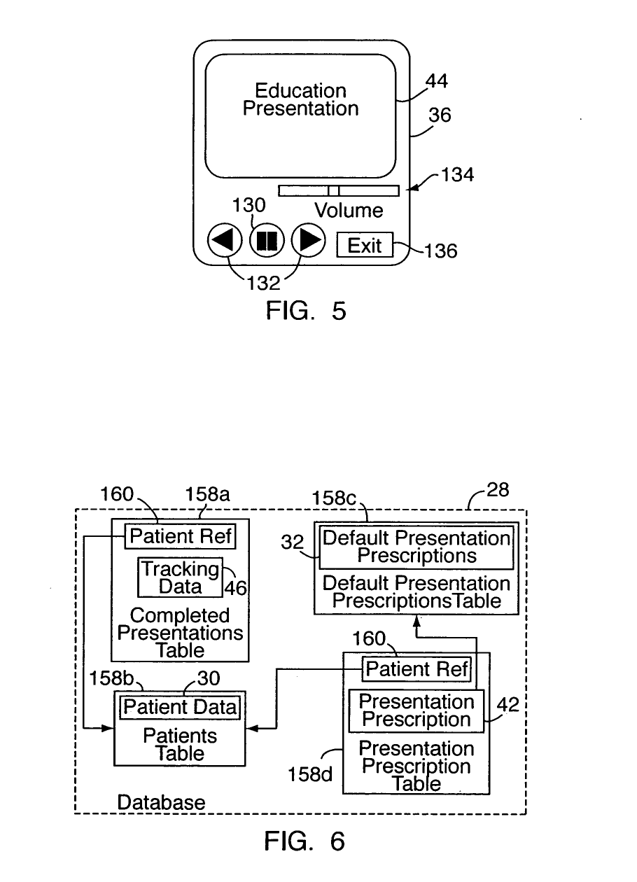

Once the start option/button 120 in the viewer screen 112 is selected, the education presentation 44 is then displayed based on the presentation prescription 42. What is displayed is also based on the selections made on the viewer screen 112. For example, if only the “video” option 118 is selected, then only the video content 40c in the content files 38 will be displayed. Additionally, if the “all assigned” option 116 is selected, then all the content files 38 associated with the selected content options in the presentation prescription will be sequentially accessed and displayed. If the “completed only” or “incomplete only” options are selected, then the tracking data 46 for the patient is also accessed for determining which content files 38 should be displayed. The tracking data 46 may be transferred from the database 28 to the patient terminal 22 for this purpose. As shown in FIG. 5, the education presentation 44 is displayed on the patient terminal's display/monitor 36, either in a full screen mode or in a window. The viewer control module 124 also displays virtual controls such as a pause/play button 130, “skip segments” buttons 132, a volume control 134, and an “exit” option 136. The skip segments buttons 132 allow the patient to skip to the next segment or the last segment. However, it will typically be the case that the patient is not allowed to fast forward or rewind, to ensure that the patient views all the displayed educational content. The patient interacts with the controls 130-136 and answers question content 40c using whatever I/O means are provided on the patient terminal 22. A “video selection” window (not shown) may also be displayed on the monitor 36, for showing what content files have been displayed, which content files remain for display, the amount of time elapsed or remaining in the education presentation, or the like. Once the education presentation is complete, or if the patient selects the “exit” button 136, the patient terminal may be configured to “lock up” or return to a password screen, to prevent unauthorized access by the patient to certain portions of the system 20.

The displayed content files 38 each contain AV content 40a, text/printed material content 40b, and/or questions content 40c, all relating to a particular medical education sub-topic 34. For example, with reference to FIG. 4 there would be a content file for “introduction to asthma,” one for “healthy anatomy,” one for “asthma diagnosis,” and so on. As noted, for each content option 92 in the listing of sub-topics of a default presentation 32, there will typically be a corresponding content file. The text or printed material content 40b provides educational text or graphical material (e.g., diagrams, drawings, text, and the like) relating to the particular medical sub-topic. The AV content 40a comprises educational video/movie clips, or possibly static images accompanied by a soundtrack, again relating to the particular medical sub-topic. Video clips, for example, may be produced in a standard manner using animation, actors recreating medical information content according to a prepared script, or both. For example, a video clip for an “introduction to asthma” sub-topic could take the form of a doctor (played by a first actor) answering various introductory/basic questions posed by a patient (played by a second actor), in a set designed to look like a doctor's office, with occasional cuts to accompanying clips of animated graphics illustrating what the doctor and patient discuss. The medical content may be developed by consulting with physicians and medical organizations, including a thorough view of scripts, text material, any diagrams/charts/drawings, questions, and the like.

As the education presentation 44 is displayed for a patient, the patient terminal control module 124 tracks the patient's progress in viewing the presentation 44. The control module 124 also tracks the patient's answers to any questions content 40c. (If the presentation 44 is displayed at the server terminal 24 or a workstation 58, the management program 60 and/or management interface 62 may be configured for the tracking function.) By “track,” it is meant to monitor and to generate data relating to what is monitored. For example, the control module 124 may monitor which content files 38 are viewed, whether they were viewed in their entireties or, if not, the duration of viewing, and the answers to any questions shown to the patient. As progress of the displayed presentation is monitored, including patient answers to displayed questions, the control module 124 also generates tracking data 46 relating thereto. The data 46 may be stored in the local database 126, in association with the patient's ID. The data 46 may also be transmitted to the server terminal 24 for storage in the database 28, either wirelessly as the data is generated, after all the data is generated, or upon connection of the patient terminal 22 to a docking station 128.

The tracking data 46 may be used as a basis of a progress or education report 48 for the patient. In effect, the report 48 comprises the data 46 as reformatted for user interpretation and viewing. Thus, the report 48 may include a listing of what content files the patient viewed, whether the files were viewed in their entirety, the answers to any questions, and/or whether or to what extent the answers were correct. For generating reports, the patient education management interface 62 includes a “reports” option 138 on the welcome screen 74. Selecting the reports option 138 leads to a “reports” screen or window 140. The reports screen 140 includes a “viewed by” button 142, which allows for reports to be selected based on who viewed the presentation, corresponding to the “set viewer” function 114 on the viewer screen 112 for selecting who viewed the presentation, e.g., the patient, the patient's family, or both. The reports window 140 also includes an “assignments list” 144. This lists the presentation prescriptions 42 assigned to the patient, family members, or both, along with an indication of how much of each education presentation 44 was viewed, date of assignment, and so on. It may also be possible to select one of the presentation prescriptions to see in more detail what the patient watched and when. The reports screen 140 also includes a “report view” 146. This is a window that automatically displays a report 48 of whatever education prescription 42 is selected in the assignments list 144. For example, when a user selects one of the presentation prescriptions, the management interface 62 automatically builds a report based on the data 46, and displays it in the report view window 146. The report includes formatted information such as patient name and/or ID, the date(s) of viewing, the percentage completed, test score (e.g., percentage of correctly answered question content), total presentation duration, and what specifically was viewed and when. If the user selects a different prescription, a report is automatically built for the presentation corresponding to that prescription. If more than one prescription is selected, a report is built for all selected presentation prescriptions in combination. The reports window 140 may include options (not shown) for showing/not showing question content 40c, for adding a signature line to the report for the patient to sign after printout, and “select all,” “clear,” and “done” options for selecting multiple prescriptions, for clearing all selected prescriptions, and for exiting the reports window, respectively. A “print” button 148 is provided for printing a report 48, using a standard printer or other output device 150.

The tracking data 46 and/or reports 48 for each patient may be stored in the database 28 as part of the patient's data record 30. The tracking data 46 and/or reports 48 may also be stored in the medical facility's clinical record system or database 86. Further, as should be appreciated, instead of the workstation and/or patient terminal transmitting tracking data 46 to the server terminal 24, reports 48 may be generated at the workstation or patient terminal and then transmitted to the server terminal for storage in the database.

The welcome screen 74 may also include a “review content” option 152, a help and/or tutorial option 154, and a “create presentations” option 156. The review content option 152 allows a user to view the content files 38 without tracking patient progress or generating report data. The help/tutorial option 156 provides standard user help functionality describing how the system 20 is used. The create presentations option 156 allows a user to create the default presentation prescriptions 32, in a manner similar to as set forth above in regards to selecting and customizing presentation prescriptions. For example, upon selecting the create presentations option 156 the user may be allowed to create, modify, and delete folders for new default prescriptions, and to populate the folders with content options selected from among all the content files stored on the system 20. In other words, the user is presented with a listing of all the content files, and may then choose one or more of the content files for a default prescription folder. Upon completing the folder, which is saved in the database 28 along with the other default prescriptions 32, the new default prescription becomes available from the assignments screen 90.

FIG. 2 summarizes operation of one embodiment of the system 20. As indicated, the server terminal 24, workstation 58, and patient terminal 22 are in communication with one another, either directly or indirectly. The workstation 58 communicates with the server terminal 24 for transfer of the patient data 30 and/or default presentation prescriptions 32 to the workstation 58 as HTML data 70. The patient data 30 and default prescriptions 32 are stored in the database 28. A medical professional or other user selects or designates a patient who is to receive patient education. The user then accesses the management interface 62 for selecting a default presentation prescription 32 on the assignments screen or window 90. Typically, the user selects the default prescription whose topic is most relevant to the medical condition of the patient. The default presentation 32 includes a number of sub-topic content options 92. The user can choose to select all the sub-topics, or only a portion thereof. For example, as shown in FIG. 2 the user has selected sub-topic content options “B.” “D,” and “E” in a “Topic 1.” Once finished, the presentation prescription 42 for the patient is generated based on the selected content options, e.g., in effect the selected content options in combination form the presentation prescription 42 for the patient. As should be appreciated, the presentation prescription 42 is a listing or assignment of medical education sub-topics that form a prescribed educational program for the patient. The presentation prescription 42 is then transmitted to the patient terminal 22. At the patient terminal, a medical education presentation 44 is automatically displayed to the patient according to the presentation prescription 42. For this, the patient terminal accesses the content files 38 (e.g., stored on the patient terminal) that correspond to the content options 92 in the prescription 42, and sequentially displays the corresponding content files, which form the education presentation 44. For example, as shown in FIG. 2, if the prescription 42 includes “B,” “D,” and “E” options, and if there are “A”-“G”, etc. content files 38 available, the patient terminal accesses the “B,” “D,” and “E” content files 38 for sequential display as the education presentation 44. (In this simplified example, there is a 1-1 correspondence between the name of a content option and the name of its corresponding content file. As implemented, a more complex linking arrangement could be used, e.g., each content option in the prescription could include the file name of its corresponding content file.) As the education presentation is displayed, its progress is automatically tracked, including generating data 46 as to what was displayed, the duration of display, patient answers to question content, or the like. The data 46 may be used to generate reports, and may be stored in the database 28 and/or clinical record system in association with the patient's data record.

Although the system 20 has been illustrated primarily as utilizing local storage of the content files 38, the content files 38 could instead be stored at a central location, e.g., the server database 28. In such a configuration, the content files 38 would be streamed over the network 26, in a standard manner, when needed. Since mass data storage is relatively inexpensive, however, local storage reduces network bandwidth usage and allows for increased playback rates (e.g., video may be at a higher resolution and can be displayed full screen) without substantial additional costs. The content files 38 may be in an MPEG format.

The database 28 and its interaction with the rest of the system 20 may be configured in a number of different manners. The database 28, for example, may be an SQL database, e.g., implemented in Microsoft SQL Server™ or mySQL™. A standalone configuration (and/or the local database 126 on the patient terminal 22) may use a non-client/server database engine such as Microsoft Access/Jet™. Macromedia Flash™ may be used as the basis for the management interface 62 and/or for the viewer control module 124. The management interface 62 and/or the viewer control module 124 may be configured to use active server pages (ASP) for communicating with the database 28, or there may be direct communication with the database. The database 28 may be internally configured in a number of different ways, as desired for organizing the data therein. An example is shown in FIG. 6. There, the database 28 includes various tables 158a-158d. A “completed presentations” table 158a is for storing/organizing the tracking data 46. The completed presentations table 158a also includes a “patient ref” field 160, which contains a patient ID or other reference connecting data to a particular patient. A “patients” table 158b is for storing/organizing the patient data 30. A default presentation prescriptions table 158c is for storing/organizing the default presentation prescriptions 42 and folders of such prescriptions. A presentation prescriptions table 158d is used for keeping track of presentation prescriptions 42. The tables may be commonly used, or patient specific, depending on the particular table. As should be appreciated, the database 28 is shown in simplified form in FIG. 6, and would typically include additional tables, each including a number of fields, sub-fields, or table entries/categories.

Referring back to FIG. 1A, instead of or in addition to using patient terminals 22 such as wireless tablet computers, the system 20 may be implemented using an integrated hospital television system 162. In particular, many medical facilities now include interactive televisions systems, such as those implemented by LodgeNet™, for providing interactive and/or tailored television content to patients. A typical system 162 includes a video server terminal 164 connected to a number of distributed televisions 166, e.g., one television per patient bed. The video server 164 directs television content to each television according to a patient's use of a remote control 168, including interactive functions such as detecting user selection of on-screen menus, options, and/or controls. For use in the system 20, the content files 38 are stored on the video server 164. An education presentation 44 is displayed for a patient on the television 166 based on the patient's presentation prescription 42, and under the control of the patient's remote control 168 (e.g., via an interface such as shown in FIG. 5). When a presentation is run on the television system 162, the system 162 queries the database 28 directly for the patient's presentation prescription 42. The television system 162 tracks the content that the patient views, and reports the tracking data 46 back to the database 28.

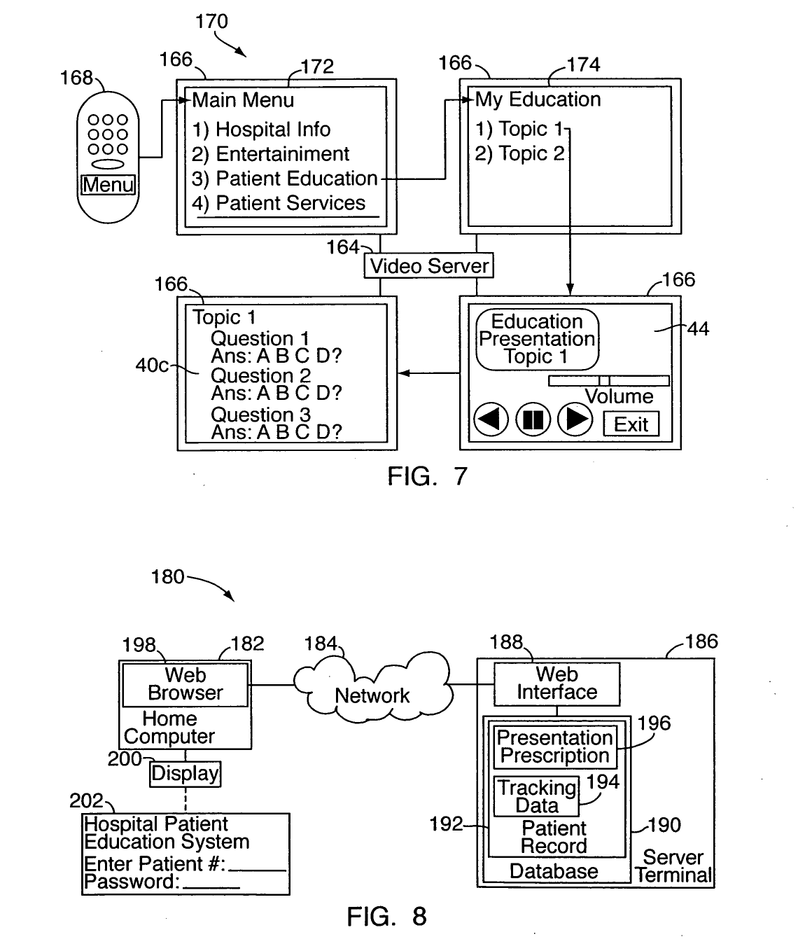

The television system 162 will typically have an interactive menu system for general hospital use. Patient education can be carried out by adding menu selections for this purpose, in a standard manner as used for configuring the television system 162, and according to what is described above in regards to the system 20. An example of a menu system 170 is shown in FIG. 7. There, upon a patient pressing a “menu” button on a remote control 168, the video server 164 displays a main menu 172 on the television 166. The main menu includes user selectable options such as “hospital info” and “patient education.”If the patient selects the “patient education” option (typically using the remote), a “my education” screen 174 is displayed on the television. The “my education” screen 174 lists the presentation prescriptions available to the patient, typically listed by topic. For example, FIG. 7 shows a “topic 1” and a “topic 2,” either of which can be selected by the patient using the remote control 168. Upon selecting “topic 1,” for example, the video server 164 displays the education presentation 44, along with virtual controls such as volume and play/pause, all controllable by the remote control 168 through standard interaction of the remote control and video server. After the AV content portion of the presentation 44 is completed, question content 40c may be displayed. The patient answers the questions by appropriately manipulating the remote control. Tracking data 46 is sent back to the database 28.

The system 20 may be configured to display content 40a-40c based on patient answers to question content 40c. For example, if a number of questions are incorrectly answered, AV content and/or text content may be automatically displayed again, or it may be designated in the tracking data 46 as not having been completely viewed.

FIG. 8 shows an alternative embodiment of the present invention. Here, a patient education system 180 is implemented for display of educational content over any network-connected computer, e.g., at a home computer 182 over the Internet 184, or at an Internet-connected hospital terminal. The home or other computer 182 may be generically configured, e.g., it does not have to be outfitted with special software for viewing educational content. The system 180 includes a remote patient education server terminal 186. (The server terminal 24 may be used as the remote server, in addition to local use as described above.) The server 186 includes a web interface 188 and a remote connection database 190 with patient records 192, each containing tracking data 194, presentation prescriptions 196, and patient data such as name and patient ID. Again, the database 28 may be used as the database 190. In operation, a patient at home accesses the home computer 182, which includes a standard web browser 198 such as Microsoft Internet Explorer™ and a monitor/display 200. The patient enters a URL (Internet address) for the web interface 188 into the web browser 198, e.g., the web interface functions as a website. The URL is provided to the patient by staff at the medical facility prior to discharge. The web interface 188 transfers HTML files to the web browser 198 for displaying a website-based user interface. The patient is greeted by a home page 202, which will typically require that the patient enter a user name (e.g., patient ID) and password. Correct entry of such information causes the web interface 188 to access the patient's record 192 in the database 190 for retrieving any presentation prescriptions 42 assigned to the patient. The prescriptions are assigned in a manner as described above, e.g., by a medical professional accessing a workstation 58 or the server I/O means 64. Education presentations 44 are then displayed on the display 200 in a manner described above. The content files 38 may be streamed over the Internet, downloaded onto the patient's home computer 182, or provided to the patient on a CD-ROM for local access at the home computer. (In such a case, the files on the CD-ROM could be encrypted for copyright protection and limited access only through the web interface 188.) Alternatively, instead of using a web browser 198, the patient could be provided with a dedicated program, e.g., on CD-ROM, for communicating with the server 186.

Although the patient education system has been illustrated as configured for use in patient education, it could be configured for education in other contexts, simply by changing the nature of the content files 38. Thus, instead of providing content files relating to a number of medical topics, the content files could relate to other topics such as assembly/manufacturing, culinary work, tax preparation, and the like. For such systems, education prescriptions would be based on an individual's education status regarding the particular topic. The system would automatically display an education presentation to the individual according to an education prescription for the individual, with the education prescription being based on the education status of the individual in relation to the educational topic. The system would then automatically track the progress of the education presentation during display to the individual.

Since certain changes may be made in the above-described patient education management database system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A method for educating patients comprising the steps of:
automatically displaying a medical education presentation to a patient according to a presentation prescription, wherein the presentation prescription is based at least in part on a medical condition of the patient, and wherein the medical education presentation includes at least one of audiovisual (AV) content and text content relating to the medical condition of the patient; and
automatically tracking progress of the medical education presentation during display to said patient.

2. The method of claim 1 wherein:
the medical education presentation further includes a plurality of questions relating to said at least one of the AV content and the text content; and
the method further comprises generating a report relating to the tracked progress of the medical education presentation and to patient answers of said questions.

3. The method of claim 2 further comprising:
storing said report in a medical facility database in association with a patient data record of said patient, said patient data record being stored in said database.

4. The method of claim 1 further comprising:
retrieving said at least one of the AV content and the text content from a memory unit of a wireless unit, wherein the medical education presentation is displayed on the wireless unit.

5. The method of claim 4 wherein said at least one of the AV content and the text content are retrieved from among a plurality of content files stored in the memory unit of the wireless unit, said plurality of content files relating to a plurality of different medical conditions for display of a plurality of medical education presentations relating to said medical conditions.

6. The method of claim 5 further comprising:
displaying a menu on a terminal, said menu including a plurality of content options relating to the medical condition of the patient and a category of said medical condition of the patient;
generating the presentation prescription based on a selection of one or more of said plurality of content options, wherein the selection of said one or more of said content options is based on the medical condition of the patient for customizing the presentation prescription and medical education presentation for the patient; and
transmitting the presentation prescription to the wireless unit.

7. The method of claim 1 further comprising:
displaying a first menu including a first plurality of content options each relating to a different medical condition category, wherein one of said first plurality of content options relates to a category of the medical condition of said patient;
displaying a second menu based on selection of said content option relating to the category of the medical condition of said patient, said second menu including a second plurality of content options relating to the medical condition of the patient; and
generating the presentation prescription based on a selection of one or more of said second plurality of content options.

8. The method of claim 7 wherein:
the first and second menus are displayed on a terminal; and
the method further comprises transmitting the presentation prescription from the terminal to a wireless unit for display of the medical education presentation on the wireless unit.

9. The method of claim 8 wherein said at least one of the AV content and the text content are retrieved from among a plurality of content files stored in a memory unit of the wireless unit, said plurality of content files relating to a plurality of different medical conditions for display of a plurality of medical education presentations relating to said medical conditions.

10. The method of claim 1 further comprising:
displaying a menu having a plurality of content options relating to at least one of the medical condition of the patient and a category of the medical condition of said patient; and
generating the presentation prescription based on selection of one or more of said content options, said selection being based on the medical condition of the patient for customizing the presentation prescription and medical education presentation for the patient.

11. The method of claim 1 further comprising:
transmitting data relating to the tracked progress of the medical education presentation to a server terminal;
storing said data on the server terminal in association with a data record of said patient; and
generating a report based on said data.

12. The method of claim 1 further comprising:
controlling a video server based on the presentation prescription for display of the medical education presentation on a distributed television system.

13. The method of claim 12 wherein:
the medical education presentation further includes a plurality of questions relating to said at least one of the AV content and the text content; and
the method further comprises tracking patient answers of said plurality of questions through patient interaction with said distributed television system.

14. The method of claim 1 wherein said at least one of the AV content and the text content are retrieved from among a plurality of content files, said plurality of content files relating to a plurality of different medical conditions for potential display of a plurality of medical education presentations relating to said medical conditions.

15. An education method comprising the steps of:
automatically displaying an education presentation to an individual according to an education prescription, wherein the education prescription is based at least in part on an education status of the individual in relation to an educational topic, and wherein the education presentation includes at least one of audiovisual (AV) content and text content relating to the educational topic; and
automatically tracking progress of the education presentation during display to said individual.

16. The method of claim 15 further comprising:
displaying a menu having a plurality of content options relating to the educational topic; and
generating the education prescription based on selection of one or more of said content options, wherein the one or more of said content options are selected based on the education status of the individual in relation to the educational topic, for customizing the education prescription and education presentation for the individual.

17. The method of claim 16 wherein said at least one of the AV content and the text content are retrieved from among a plurality of content files, said plurality of content files relating to a plurality of different educational topics for potential display of a plurality of education presentations relating to said educational topics.

18. The method of claim 17 wherein:
the education presentation further includes a plurality of questions relating to said at least one of the AV content and the text content; and
the method further comprises generating a report relating to the tracked progress of the education presentation and to answers of said plurality of questions by said individual.

19. The method of claim 18 wherein:
the menu is displayed on a terminal; and
the method further comprises transmitting the education prescription from the terminal to a wireless unit for display of the education presentation on the wireless unit, wherein the plurality of content files are stored on the wireless unit.

20. A method for educating patients comprising the steps of:
displaying a first menu having a first plurality of content options relating to a medical topic, said medical topic relating to a medical condition of a patient;
generating a presentation prescription based on a selection of one or more of said first plurality of content options, said selection being based at least in part on the medical condition of the patient;
displaying a medical education presentation to the patient according to the presentation prescription, wherein the medical education presentation includes (i) at least one of audiovisual (AV) content and text content relating to the medical topic and (ii) a plurality of questions relating to said at least one of the AV content and the text content; and
tracking (i) progress of the medical education presentation during display to said patient and (ii) answers to said plurality of questions by the patient.

21. The method of claim 20 wherein:
the first menu is displayed on a terminal; and
the method further comprises transmitting the presentation prescription from the terminal to a wireless unit, wherein the medical education presentation is displayed on the wireless unit, and wherein said at least one of the AV content and the text content is stored on the wireless unit.

22. The method of claim 20 further comprising:
displaying a second menu having a second plurality of content options each relating to a different medical topic, wherein a first one of said second plurality of content options relates to said medical topic relating to the medical condition of the patient, and wherein the first menu is displayed based on a selection of said first one of said second plurality of content options.

23. A system for educating individuals, said system comprising:
a client terminal having a display, a memory unit, and user input/output means;
a control module interfaced with the client terminal, said control module being configured to control the client terminal for display of an education presentation to an individual according to an education prescription, wherein the education prescription is based at least in part on an education status of the individual in relation to an educational topic, and wherein the education presentation includes at least one of audiovisual (AV) content and text content relating to the educational topic; and
wherein the control module is further configured to track progress of the education presentation during display to said individual.

24. The system of claim 23 wherein:
the education presentation further includes a plurality of questions relating to said at least one of the AV content and text content; and
the control module is further configured to track answers to said plurality of questions by said individual, as entered into the client terminal through said input/output module.

25. The system of claim 24 further comprising:
a server terminal in communication with the client terminal, said server terminal being configured to store data relating to the tracked progress of the education presentation and answers, as received from the client terminal.

26. The system of claim 25 wherein the client terminal is a wireless unit and the server terminal includes a wireless communication module for communicating with the client terminal.

27. The system of claim 25 wherein the server terminal is interfaced with a database for retrieval of information relating to said individual from said database, and for storing said data relating to the tracked progress of the education presentation and answers in said database, in association with a data record of said individual.
